(19) United States
(12) Patent Application Publication
(10) Pub. No.: US 2004/0098206 A1
(43) Pub. Date: May 20, 2004

(54) System and method for management of specimens

(76) Inventors: Gordon Leonard Milliken, Rossmore (AU); Russell Duncan, Sydney (AU); David Mitchell, Turramurra (AU)

Correspondence Address: TUCKER, ELLIS & WEST LLP, 1150 HUNTINGTON BUILDING, 925 EUCLID AVENUE, CLEVELAND, OH, 44115-1475, US

(21) Appl. No.: 10/381,115

(22) PCT Filed: Sep. 21, 2001
(86) PCT No.: PCT/AU01/01181

(51) Int. Cl. G06F 19/00; G01N 31/00

(52) U.S. Cl. 702/31

(57) ABSTRACT

A system and method for the management of specimens, and particularly for the management of cryogenically stored biological specimens. The management functions can be performed remotely via the Internet. Management functions include the establishment, dispatch, retrieval, delivery to third parties, disposal, etc., of the samples. Environmental factors of the cryogenic storage means can be controlled, and varying access may be authorised. Data pertaining to the samples may be logged for historical data, analysed, processed in report form, etc. The specimens may be biological specimens, or samples of plants, plant extracts, insects or other samples. The specimens may be stored in ambient, refrigerated, frozen, ultracold, cryogenic or other environmental conditions.

### TECHNICAL FIELD

The present invention relates to a system and method for the management of specimens. The system and method is particularly applicable, although not limited to, the management of cryogenically stored biological specimens, whereby management functions may be performed remotely via the Internet. The system may, for example, be used for the management of the specimens such as plants, plant extracts, insects, extracts of insects or other natural specimens, and, the storage of the specimens may be performed at ambient, refrigerant, frozen (e.g. −20° C.), ultracold (e.g. −80° C.), or other temperatures and environmental conditions.

### BACKGROUND OF THE INVENTION

The reference to any prior art in this specification is not, and should not be taken as, an acknowledgement or any form of suggestion that that prior art forms part of the common general knowledge in Australia.

The storage time of biological specimens is known to be extended by cooling such specimens to “cryogenic” temperatures. Biological specimens stored using cryogenics includes plasma, DNA, cell lines, and tissues. There are various approaches to cryo-preservation of biological specimens, each of which require the control of the storage condition parameters, such that a cryobiologist is able to bring the specimens to cryogenic temperatures and then return them to physiological conditions, without injury.

The storage of biological samples involves the collation of a large amount of data pertaining to each individual specimen. Each specimen must be categorised according to the type of specimen, the storage conditions required, the storage duration, etc. The management of data pertaining to cryogenically stored biological specimens is critical to optimise the probability of successfully storing the sample and being able to conveniently access the sample when required, but has herebefore typically been recorded manually, possibly with the use of stand-alone PCs utilising Excel spreadsheets or Microsoft Access. The Internet has changed the fundamental aspects of the way scientists work in that it provides a unique forum for the dissemination and exchange of information. The Internet provides a forum whereby collective information can be exchanged at a rapid rate and whereby various systems can be remotely managed.

In a networked data communications system, users have access to terminals which are capable of requesting and receiving information from local or remote information sources. In such a system a terminal may be any type of computer or computerised device, a personal computer (PC), a mobile or cellular phone, a mobile data terminal, a portable computer, a personal digital assistant (PDA), a pager, or any other similar type of electronic device. The capability of the terminal to request and/or receive information can be provided by an application program, hardware or other such entity. A terminal may be provided with associated devices, for example an information storage device such as a hard disk drive.

In such a system an information source may be a server or any other type of terminal (for example, a PC computer) coupled to an information storage device (for example, a hard disk drive). The exchange of information (i.e., the request and/or receipt of information) between the terminal and the information source, or other terminal(s), is facilitated by a connection referred to as a communication channel. The communication channel can be physically realised via a metallic cable (for example, a telephone line), semi-conducting cable, an electromagnetic signal (for example, a radio frequency (RF) signal), an optical fibre cable, a microwave link, a satellite link or any other such medium or combination thereof connected to a network infrastructure.

The infrastructure may be a telephone switch, a base station, a bridge, a router, or any other such specialised component, which facilitates the connection between the terminal and the network Collectively, the interconnected group of terminals, physical connections, infrastructure and information sources is referred to as a computer network or data communications network.

The computer network itself may take a variety of forms. It may be located within a local geographic area, such as an office building, and consist of only a limited number of terminals and information sources. This type of computer network is commonly referred to as a Local Area Network (LAN). On a broader scale, it may be larger and support more users over a wider geographic area, such as across a city. This type of network is commonly referred to as a Wide Area Network (WAN). On an even broader scale LAN and WAN networks may be interconnected across a country or globally. An example of a globally connected computer network is the Internet.

### SUMMARY OF THE INVENTION

In one broad form, the present invention provides a system for the management of specimens.

Preferably, the specimens are biological samples, but alternatively, the specimens may be plants, plant extracts, insects, or any other samples or specimens.

Preferably, said stored biological samples or other specimens are stored under cryogenic conditions.

Also preferably, however, the specimens may be stored in other environmental conditions, such as ambient, refrigerated, frozen, ultracold or other conditions.

Preferably, said stored biological samples or other specimens are managed remotely from storage means, via a computer network, such as the Internet.

Preferably, the management of said biological samples or other specimens includes the control of the environmental conditions at said storage means.

Preferably, said environmental conditions includes temperature, humidity, etc., of one or more freezer unit.

Preferably, said environmental conditions may be set or adjusted.

Preferably, said system includes a profile database having profile data correlating to sample data of said biological samples or other specimens.

Preferably, said profile database is searchable for identification of predetermined parameters pertaining thereto.

Preferably, said profile database is searchable from a remote location, via a computer network, such as the Internet.

Preferably, the management of said system includes the instruction of setting up, retrieval, delivery to third parties, and/or, disposal of said biological samples or other specimens.

Preferably, the management of said system is controllable by one or more users. Preferably, said system includes authentication means to authenticate the authority of said one or more users to manage said system.

Preferably, said authentication means includes the supply of a user name and password, the use of biometric (e.g. fingerprint or iris scan) identification means, and/or other authentication means.

Preferably, a user can access the management system from any type of terminal. Preferably, varying levels of authentication means are enabled to different users, dependent upon individual access and management authorities.

Preferably, said system includes validation means for indication to a user of a management instruction.

Preferably, said validation means includes the supply of return data or some means of visual indication (such as the greying of a screen) being provided to the user.

Preferably, said system includes logging means, to record ongoing data pertaining to each sample/specimen or groups of samples/specimen.

Preferably, historical data pertaining to said sample/specimen or groups of samples/specimens is retrievable from said logging means.

Preferably, said system further includes analysing means to analyse data pertaining to a sample/specimen or groups of samples/specimens, produce reports thereabouts, etc.

Preferably, said system uses one or more graphical interface.

Also preferably, said system includes replication and/or queuing means.

Preferably, said system is used for the management of biological samples or other specimens by academic and/or research institutions, pathology practices, clinical trial purposes, agricultural purposes, etc.

Preferably, the present invention provides that the system may utilise a computer network which be any network of two or more communicating computers or terminals including but not limited to, an internetwork, an intranetwork, a LAN, a WAN, or the Internet.

Preferably, in accordance with the present invention information or data is exchanged by means including but not limited to: metallic cables; semi-conducting cables; optical fibre cables; satellite links; electromagnetic waves; microwave links; exchanging of memory devices; or any other such medium or combination thereof connected to a network infrastructure.

In another preferred form of the invention there is provided a computer-readable medium of instructions for management of stored biological samples.

In yet another preferred form of the invention there is provided a method for the management of stored biological samples or other specimens.

In a further broad form, a system for the management of stored biological specimens, including:

a repository of biological specimens, each specimen having sample data pertaining thereto;

a processor, including:

a database containing profile data correlating to said sample data;

searching means for one or more user to search said database; and

control means, for one or more user to control the management of said specimens, including the retrieval, delivery and disposal of each sample, and, the environmental conditions in which each sample is stored.

Preferably, said processor is accessed by said one or more user from a remote location, such as via the Internet.

Also preferably, said processor includes authentication means to authenticate the authority of said one or more users, wherein each said one or more users may have differing authority levels.

Also preferably, said processor further includes identification means to determine the identity of each of said one or more users, wherein said identification means includes the supply of a user name and password, the use of biometric identification means, or other like identification means.

In yet a further broad form, the present invention provides a method for managing the storage of biological specimens, including the steps of:

providing a repository of biological specimens, each specimen having been sampled to obtain sample data pertaining thereto;

entering profile data, correlating to said sample data of said biological specimens into a database;

managing the identification retrieval, delivery and disposal of each sample, and, the environmental conditions in which each sample is stored via a control means by one or more user.

Preferably, said one or more user accesses said database and/or said control means from a remote location via a communications carrier, such as via the Internet.

Also preferably, said managing step further includes authenticating the authority of said one or more user, wherein users may have a differing authority level.

Also preferably, said managing step further includes identifying said one or more user, including by the supply of a user name and password, the use of biometric identification means, or other like identification means.

In a further broad form, the present invention provides a computer readable medium of instruction for the management of stored biological samples.

### DETAILED DESCRIPTION OF PREFERRED EMBODIMENTS

The present invention will become more fully understood from the following detailed description of the preferred but non-limiting embodiments thereof.

The system and method of the present invention has been established to provide a secure, off-site, low-temperature storage facility for specimens such as plasma, DNA, cell lines, tissues and other biological specimens, for natural or artificial products, including plants, plant extracts, insects, etc. At a central storage facility, unique identifiers streamline sample handling and processing, while the proprietary inventory management system stores all sample data and user defined information. Sample information can be securely accessed at any time via the Internet.

The inventory management system of the present invention permits persons to access information about the samples at any time via the Internet. This management service stores all data associated with the sample including location, temperature records and all user-defined information. Individual persons or corporations are able to define and/or determine the security level of access required from username/password through to biometric identification (e.g. fingerprint or iris scan). The audit trail is able to determine the complete history of a sample including every movement within the facility, the time and duration of each opening of the storage vessel and who accessed the vessel.

Parties can use the system to access all information about all or a determined selection of the samples, request retrieval, delivery to third parties or disposal. Additionally, controls on who has access to the material, who can move, retrieve or dispose of samples can easily be established. Parties can select their own identification system for vials based on their own requirements.

Parties are able to access the database via their web browser to store information about samples. They may store the information on their own premises or they can record sample information via the browser and request storage of the samples from a centralised facility.

Some of the individual modules that make up the software are:

Wizards used to configure protocols include the following:

Freezer wizard

a Box wizard

Vial wizard

User definable data types for fields to record data, include the following:

Data (collection data, test data, storage data, processing data)

Type (blood, serum, plasma, urine, semen, seeds)

Storage conditions (ambient, refrigerant, frozen (e.g. −20° C.), ultracold (e.g. −80° C.), cryogenic, etc.)

Storage duration, eg. Store until advised, specific date, time from receipt of samples.

Users can process various on-line requests including the following:

Add box and vial data

Request sample shipping to centralised location

Request return of samples to user or other party

Request disposal of samples

On-line monitoring of the environmental conditions of individual sample, such as temperature

Request archival report of environmental conditions

Searches on any data fields to select samples with defined characteristics include the following:

Analysis of data

Produce reports based on database searches, hard copy or file.

Access to the system may be determined by the user. By setting up a hierarchy of access, the user can determine what level of access privileges they or their employees are assigned. A key user, for example, may be permitted full system access so that they can set up the system parameters, such as, freezer, box and vial configurations and then construct a storage protocol. A more junior member of staff may only be able to add samples and information, whereas, another employee may be able to make database queries on all of the data in their department.

Once a storage protocol has been set up, the user can add sample data. All samples that are stored on the database are identified by a barcode number, or the like. The system can accommodate all common barcode formats.

The first step is to record the storage box details, including the box barcode number. The vials are then added to the box. At this point, the system automatically allocates the next available storage position—the random placing of vials in a box is not permitted.

If the user wishes to ship the samples to a centralised storage facility, a request for shipping may be sent, via email. The centralised facility will then act on this request and arrange the appropriate shipping.

Upon receipt of the samples at the centralised storage facility, the box is assigned a storage location by the system. By linking the box ID with the individual vial ID's, the system can report such information as environmental monitoring down to the individual vial level.

The described embodiment of the system and method of the present invention has been designed from the ground-up as a web based application. As such, the system provides global access to the same data elements at the same time. There are no special configuration requirements, however, and the system may be supported on a variety of platforms, including Mac and PC Internet platforms. The other feature of web based systems is that the transaction security is based on known third party standards.

It will be appreciated that the present invention, rather than being around the object stored (vial), is based around the process. This means that in the present system, users define protocols for storage, and this then drives the other parts of the process. The application may typically impose regiments such as:

You can't store this vial in this box (it's too big)

You can't use this protocol (it belongs to someone else)

The application will tell you where to store a vial (but can be overridden)

The system of the present invention may be implemented whereby it uses graphical representations of various aspects, such as the box, freezer, etc.

It will be understood that the system of the present invention uses a high level of audit control. There is a copy of every record ever made. Every time a box is moved the transaction is recorded and a copy kept. This will provide a complete audit trail.

As such, the system of the present invention will integrate environmental monitoring with storage records. For every record, the user will be able to see a temperature graph of the storage conditions.

The system of the present invention is designed to be preferably used within an Internet framework. This includes the usual client side HTML web pages and extends to the replication of data between servers connected via the Internet.

When data is changed on one server, it is preferably replicated to at least one other server in the domain. This design is enabled by every business object being able to be called from the web server and also from the “router”. The router is the software component of the system that receives (or sends) database updates between servers.

Every database table and all key allocation is handled within a common business object. These are configurable per installation.

Rather than writing the data in real time across the Internet the transactions are queued and held locally until they can be forwarded. This provides a measure of recovery in case of database server melt down.

The design of the system to include replication and queuing minimises the possibility that data will be lost in the event of a node failure. It also permits the continued operation of the system in the event of breakdown in communication between the various nodes. In the same way that samples are distributed over the system (on and off-site) data is also distributed.

The following table, labelled Table 1, provides a listing of various components of the system of the present invention, a description of same and of their functionality.

TABLE

| Component | Description | Functionality |
|---|---|---|
| Freezer wizard | Client can select a freezer | Clients define the arrangement of the shelves/racks and boxes in the freezer. |
| | configuration from a list of freezers or | The application is then able to calculate the number of storage units (eg |
| | input user defined configuration | boxes) that the freezer can store. It is also the basis from which capacity |
| | | data is calculated. |
| Box wizard | Allows client to define the dimensions | The box is treated as a matrix with alpha characters used to label the X axis |
| | of the storage unit and the number of | and numeric characters to label the Y axis. Eg for a 100 place box, the |
| | vials that can be stored | matrix would be A-J, I-10. |
| Vial wizard | Client can define the dimensions of the | Data that can be defined is, height, diameter, volume, internal or external |
| | storage vial | thread. |
| Vial storage allocation | Automatic allocation of vial | After a box has been defined and a number assigned using a barcode, the |
| | | client can commence storing vials. The application automatically assigns |
| | | the next available vial location. |
| Hierarchy of storage | Permits the user to define a hierarchy | The application directs the placement of items for storage. This permits |
| requirements | of storage requirements. | users and management to develop a hierarchy of “placement directives” in |
| | | relation to incoming samples. Eg. A new box to be stored in the facility will |
| | | be automatically assigned a place near to existing samples from the same |
| | | client. Or conversely will be stored in a separate freezer from all existing |
| | | material. |
| Adding sample data | Allows input of data about the sample | Clients can input data attached to the sample. This data is stored on the |
| | | Cryosite database server. The individual samples are identified by a |
| | | barcode number, the system records and tracks movement of the sample |
| | | through the system by this unique number. |
| Box storage location | Automatic allocation of box storage | System automatically assigns a box storage location in the nominated |
| | position | storage location |
| Environmental monitoring | On-line monitoring of freezer | Client is able to view current temperature of the freezer in which any |
| | temperature | individual samples is stored. Can also request report on historical records |
| Database searches | Dynamically configurable searches | Clients can search on user-defined categories and alter these dynamically. |
| | | The results obtained presented as a hard copy report or as a file (Word or |
| | | Excel) |
| Integration | The storage management component | Included are the courier system, finance system, monitoring systems. |
| | integrates with all of the other | security systems. |
| | supporting systems | |
| Sample audits | Client can enquire on their samples | Whether samples are stored on-site or off-site, clients can produce a |
| | | complete list of samples that have been registered on the database. |
| | | Depending on the access levels |
| Security | A high security module provides | Physical security. All freezers have been modified by the addition of |
| | protection against physical and | proximity readers to control and monitor access. |
| | electronic tampering | Data security - 128 bit encryption, Virtual Private Network, Encrypted data |
| | | storage |
| | | Security is also implemented by administrative users selecting a level of |
| | | “time-out”, whereby users are logged out of the system after a defined |
| | | period of inactivity. |
| User configuration | Users can configure their own storage | This set-up allows users to define both physical attributes of the equipment, |
| | protocols | such as, box dimensions, and information attributes, (eg. sample type, test |
| | | result) |
| WAP Support | Management is able to use a WAP | This permits the use of portable WAP enabled devices to be used to receive |
| | based interface to receive system | system alerts. |
| | alerts. | |
| Courier Interface | Permits the user to tack the movement | This permits the user to track the progress of shipments to and from the |
| | of samples that are in transit. | central facility by having the application interface with the tracking software |
| | | of the courier company. |
| Integration with handheld | Permits direct inventory updating. | The user will be able to use wireless handheld devices to interrogate the |
| devices. | | database and track inventory movements in real-time. |
| Biometric authentication | Users can require biometric | The user will be able to require that biometric (or other) identification is |
| | authentication | needed before certain processes can be authorised. Eg. The destruction of |
| | | samples. |
| User zones | Different zones for different user | The administrative function can define user “zones” that permit access to |
| | groups | information within the database. This is used on an institution wide basis to |
| | | share varying amounts of information between user groups. |
| Store/Recall function | Permits the user to ship/recall samples | The user will be able to designate samples (usually in conjunction with the |
| | from an off-site facility | search function) to be shipped to or from an off-site storage facility. |

The following table, labelled Table 2, lists various layers of a preferred embodiment of a system of the present invention, the main layers being the user, business and database layers.

| | | |
|---|---|---|
| Class Name | Class Type | Business Layer |
| bEntity | Method Name | |
| | Read | |
| | Update | |
| | Insert | |
| | ReadBlank | |
| Class Name | Class Type | Business Layer |
| BEntityList | Method Name | |
| | Search | |
| Class Name | Class Type | Business Layer |
| bEntityListBoxes | Method Name | |
| | FLBEntityType | |
| | FLBEntityStatus | |
| | FLBBankName | |
| | FLBSellerStatus | |
| | FLBCollectMethod | |
| | FLBAcctType | |
| | FLBBuyerStatus | |
| | FLBCreditBand | |
| | FLBPayMethod | |
| Class Name | Class Type | Business Layer |
| bFreezer | Method Name | |
| | Read | |
| | Update | |
| | Insert | |
| | FillListBoxCustomer | |
| | Delete | |
| | FillListBoxSite | |
| | ReadBlank | |
| | FillListBoxFreezer | |
| Class Name | Class Type | Business Layer |
| bFrelist | Method Name | |
| | Search | |
| Class Name | Class Type | Business Layer |
| bLocation | Method Name | |
| | FLBLocationStatus | |
| | Update | |
| | FLBLocationType | |
| | FLBLocationCountry | |
| | FLBLocationState | |
| | FLBProVilType | |
| | Read | |
| | Insert | |
| | ReadBlank | |
| Class Name | Class Type | Business Layer |
| bLocationList | Method Name | |
| | Search | |
| | FLBLocationType | |
| Class Name | Class Type | Business Layer |
| bPerson | Method Name | |
| | Read | |
| | Search | |
| | FLBPersonActive | |
| | FLBPersonTitle | |
| | FLBPersonType | |
| | Update | |
| | ReadBlank | |
| | DelRoleRow | |
| | FLBRoleList | |
| | Insert | |
| | RoleInsert | |
| Class Name | Class Type | Business Layer |
| bProtocol | Method Name | |
| | Read | |
| | FLBProBxtType | |
| | FLBProTrlType | |
| | FLBProStorLen | |
| | Update | |
| | ReadBlank | |
| | FLBProSamType | |
| | FLBProVilType | |
| | FLBProFreType | |
| | FLBProSamFateType | |
| | Insert | |
| | FLBProSite | |
| | FLBConDatatype | |
| Class Name | Class Type | Business Layer |
| bProtocolList | Method Name | |
| | Search | |
| Class Name | Class Type | Business Layer |
| bProtocolManual | Method Name | |
| | ReadMan | |
| | ReadBlankMan | |
| | UpdateMan | |
| | InsertMan | |
| | ReadVial | |
| Class Name | Class Type | Business Layer |
| bRole | Method Name | |
| | Read | |
| Class Name | Class Type | Business Layer |
| bSeller | Method Name | |
| | ReadTrans | |
| Class Name | Class Type | Business Layer |
| bvial | Method Name | |
| | ReadVial | |
| | Update | |
| | Insert | |
| | ReadBlank | |
| Class Name | Class Type | Business Layer |
| bVialList | Method Name | |
| | Search | |
| | FLBVilProt | |
| Class Name | Class Type | Business Layer |
| bVialType | Method Name | |
| | FLBVialMat | |
| | Read | |
| | Update | |
| | Insert | |
| | Search | |
| | ReadBlank | |
| Class Name | Class Type | User Layer |
| uBox | Method Name | |
| | box edit | |
| Class Name | Class Type | User Layer |
| uBoxList | Method Name | |
| | box search | |
| Class Name | Class Type | User Layer |
| uBoxType | Method Name | |
| | box type edit | |
| Class Name | Class Type | User Layer |
| uBoxTypeList | Method Name | |
| | box type search | |
| Class Name | Class Type | User Layer |
| uCapacityDetail | Method Name | |
| | CapacityDetail | |
| Class Name | Class Type | User Layer |
| uCapacitySearch | Method Name | |
| | capacity search | |
| Class Name | Class Type | User Layer |
| uControl | Method Name | |
| | control search | |
| | ControlEdit | |
| Class Name | Class Type | User Layer |
| uDatatype | Method Name | |
| | DataType View/Edit | |
| Class Name | Class Type | User Layer |
| uDataTypeList | Method Name | |
| | Data Type Search | |
| Class Name | Class Type | User Layer |
| uEntity | Method Name | |
| | entity view/edit | |
| Class Name | Class Type | User Layer |
| uEntityList | Method Name | |
| | entity search | |
| Class Name | Class Type | User Layer |
| ufreezer | Method Name | |
| | Freezer View/Edit | |
| Class Name | Class Type | User Layer |
| ufreList | Method Name | |
| | freezer search | |
| Class Name | Class Type | User Layer |
| UGenericScreens | Method Name | |
| | Generic Search | |
| | Generic View/Edit | |
| Class Name | Class Type | User Layer |
| uLocation | Method Name | |
| | location view/edit | |
| Class Name | Class Type | User Layer |
| uLocationList | Method Name | |
| | location search | |
| Class Name | Class Type | User Layer |
| uPerson | Method Name | |
| | person view/edit | |
| Class Name | Class Type | User Layer |
| uPersonList | Method Name | |
| | person search | |
| Class Name | Class Type | User Layer |
| uProtocol | Method Name | |
| | protocol edit | |
| Class Name | Class Type | User Layer |
| uProtocolList | Method Name | |
| | ProtocolSearch | |
| Class Name | Class Type | User Layer |
| uRole | Method Name | |
| | RoleList | |
| Class Name | Class Type | User Layer |
| uRoleList | Method Name | |
| | Role List | |
| Class Name | Class Type | User Layer |
| uVial | Method Name | |
| | ProtocolManViewEdit | |
| | vial view/edit | |
| Class Name | Class Type | User Layer |
| uVialList | Method Name | |
| | vial search | |
| Class Name | Class Type | User Layer |
| uVialType | Method Name | |
| | vialtype view/edit | |
| Class Name | Class Type | User Layer |
| uVialTypeList | Method Name | |
| | vialtype search | |
| Class Name | Class Type | User Layer |
| uWelcome | Method Name | |
| | home | |
| Class NameClass Name | Class Type | Business Layer |
| bBox | Property Name | |
| | box_active | Description |
| | smp_id | Description |
| | box_entkey | Description |
| | box_name | Description |
| | box_id | Description |
| | box_cstid | Description |
| | box_height | Description |
| | box_width | Description |
| | box_depth | Description |
| | box_comments | Description |
| | smp_name | Description |
| | bxt_name | Description |
| | box_prtkey | Description |
| | box_prot | Description |
| | box_key | Description |
| | bxt_xstart | Description |
| | bxt_xlength | Description |
| | smp_cstid | Description |
| | bxt_ystart | Description |
| | bxt_ylength | Description |
| | box_frepos | Description |
| | box_rckpos | Description |
| | box_shlpos | Description |
| | bop_x | Description |
| | bop_y | Description |
| | smp_key | Description |
| | box_frekey | Description |
| | box_rcpkey | Description |
| Class NameClass Name | Class Type | Business Layer |
| bBoxList | Property Name | |
| | box_cstkey | Description |
| | box_loc | Description |
| | box_name | Description |
| | box_id | Description |
| | box_cstid | Description |
| | box_lastupdwhen | Date |
| | box_bxtkey | Description |
| | prt_name | Description |
| | box_key | Description |
| | in_box_id | Description |
| | in_box_cstid | Description |
| | in_box_prot | Firstname |
| Class NameClass Name | Class Type | Business Layer |
| bBoxType | Property Name | |
| | bxt_key | Description |
| | bxt_type | Description |
| | bxt_xlength | Description |
| | bxt_ylength | Description |
| | bxt_width | Description |
| | bxt_comments | Description |
| | bxt_lastupdwhen | Date |
| | bxt_name | Description |
| | bxt_active | Description |
| | bxt_xstart | Description |
| | bxt_ystart | Description |
| | bxt_height | Description |
| | bxt_depth | Description |
| | bxt_lastupdby | Description |
| | bxt_lastupdaction | Description |
| | in_bxttype | Description |
| Class NameClass Name | Class Type | Business Layer |
| bControl | Property Name | |
| | prt_key | Description |
| | prt_name | Description |
| | ct2_text | Description |
| | prt_key | Description |
| | ct2_type | Description |
| | ct2_key | Description |
| | ct2_top | Description |
| | ct2_visible | Description |
| | ct2_name | Description |
| | ct2_valuereqd | Description |
| | ct2_tabnum | Description |
| | ct2_left | Description |
| | ct2_width | Description |
| | ct2_height | Description |
| | ct2_tabstop | Description |
| | ct2_tabindex | Description |
| | ct2_prtkey | Description |
| | ct2_visible | Description |
| | ct2_lastupdby | Description |
| | ct2_lastupdwhen | Date |
| Class NameClass Name | Class Type | Business Layer |
| bdatatype | Property Name | |
| | dat_key | Description |
| | dat_lastupdwhen | Date |
| | dat_name | Description |
| | dat_lastupdby | Description |
| Class NameClass Name | Class Type | Business Layer |
| bDataTypeList | Property Name | |
| | dat_key | Description |
| | in_name | Description |
| | dat_name | Description |
| Class NameClass Name | Class Type | Business Layer |
| bEntity | Property Name | |
| | ent_rg_psnkey | Description |
| | ent_hl_psnkey | Description |
| | ent_defdel_location | Description |
| | ent_hl_psnname | Description |
| | ent_key | Integer |
| | ent_abn | Description |
| | in_key | Description |
| | ent_website | Description |
| | ent_acn | Description |
| | ent_id | Description |
| | ent_trade_name | Description |
| | ent_admin_lockey | Integer |
| | ent_defdel_lockey | Integer |
| | ent_reg_name | Description |
| | ent_admin_location | Description |
| | ent_rg_psnname | Description |
| | ent_since | Date |
| | ent_lastupdby | Description |
| | ent_lastupdwhen | Date |
| | ent_lastupdaction | Description |
| | ent_active | Description |
| Class NameClass Name | Class Type | Business Layer |
| BEntityList | Property Name | |
| | in_name | Description |
| | in_id | Description |
| | ent_key | Description |
| | ent_reg_name | Description |
| | ent_id | Description |
| Class NameClass Name | Class Type | Business Layer |
| bFreezer | Property Name | |
| | FRE_FREXSTART | Description |
| | FRE_ID | Description |
| | FRE_NAME | Description |
| | FRE_MAXTEMP | Description |
| | FRE_POLFREQ | Integer |
| | FRE_FREXLEN | Integer |
| | IN_KEY | Integer |
| | FRE_FREYSTART | Description |
| | FRE_COMMENT | Description |
| | FRE_KEY | Integer |
| | FRE_MINTEMP | Description |
| | FRE_TYPE | Description |
| | FRE_LASTUPDWHEN | Date |
| | FRE_FREYLEN | Integer |
| | FRE_SHLXSTART | Description |
| | FRE_SHLYSTART | Description |
| | FRE_RCKXSTART | Description |
| | FRE_CSTKEY | Integer |
| | FRE_SITKEY | Integer |
| | FRE_RCKYSTART | Description |
| | FRE_NOSHELVES | Integer |
| | FRE_NOLOC | Integer |
| | FRE_SHLXLEN | Integer |
| | FRE_SHLYLEN | Integer |
| | FRE_RCKXLEN | Integer |
| | FRE_RCKYLEN | Integer |
| Class NameClass Name | Class Type | Business Layer |
| bFrelist | Property Name | |
| | fre_name | Description |
| | fre_noshelves | Integer |
| | in_freid | Description |
| | in_frename | Description |
| | fre_key | Integer |
| | fre_id | Description |
| Class NameClass Name | Class Type | Business Layer |
| bLocation | Property Name | |
| | loc_entkey | Description |
| | loc_status | Description |
| | loc_name | Description |
| | loc_add1 | Description |
| | loc_add3 | Description |
| | loc_state | Description |
| | loc_pcode | Postcode |
| | loc_key | Description |
| | loc_type | Description |
| | loc_shortname | Description |
| | loc_add2 | Description |
| | loc_city | Description |
| | loc_country | Description |
| | loc_phone | Description |
| | loc_fax | Phone No |
| | loc_notes | Description |
| | loc_lastupdwhen | Date |
| | in_key | Integer |
| | loc_lastupdby | Description |
| | loc_lastupdaction | Description |
| | loc_add4 | Description |
| | loc_entname | Description |
| | loc_ean | Description |
| Class NameClass Name | Class Type | Business Layer |
| bLocationList | Property Name | |
| | in_name | Description |
| | in_shortname | Description |
| | in_type | Description |
| | loc_shortname | Description |
| | loc_entname | Description |
| | loc_name | Description |
| | loc_type | Description |
| | loc_status | Description |
| | loc_key | Description |
| | loc_entkey | Description |
| | loc_add1 | Description |
| | loc_add2 | Description |
| | loc_add3 | Description |
| | loc_add4 | Description |
| | loc_city | Description |
| | loc_country | Description |
| | loc_fax | Description |
| | loc_lastupdaction | Description |
| | loc_lastupdby | Description |
| | loc_lastupdwhen | Description |
| | loc_notes | Description |
| | loc_pcode | Description |
| | loc_phone | Description |
| | loc_state | Description |
| | loc_ean | Description |
| Class NameClass Name | Class Type | Business Layer |
| bPerson | Property Name | |
| | ent_reg_name | Description |
| | psn_wkfax | Description |
| | psn_hmemail | Description |
| | psn_password | Description |
| | psn_initcalkey | Description |
| | psn_familyname | Description |
| | psn_lastupdby | Description |
| | psn_lastupdwhen | Date |
| | psn_lastupdaction | Description |
| | psn_givenname | Description |
| | psn_dob | DOB |
| | in_familyname | Firstname |
| | in_givenname | Firstname |
| | in_dob | DOB |
| | psn_name | Date |
| | psn_wkphone | Phone No |
| | psn_hmfax | Phone No |
| | psn_wkemail | Description |
| | psn_type | Description |
| | psn_status | Description |
| | psn_key | Integer |
| | psn_title | Description |
| | psn_namesuffix | Description |
| | pre_key | Description |
| | zTab4ent_key | Description |
| | zTab4rol_key | Description |
| | pro_key | Description |
| | psn_active | Description |
| | psn_maidenname | Description |
| | psn_prefername | Description |
| | psn_hmphone | Description |
| | psn_username | Description |
| | psn_desc | Description |
| | psn_notes | Description |
| | rol_name | Description |
| Class NameClass Name | Class Type | Business Layer |
| bProtocol | Property Name | |
| | prt_name | Description |
| | prt_frekey | Description |
| | prt_bxtkey | Description |
| | prt_smpfate | Description |
| | prt_trlkey | Description |
| | prt_message | Description |
| | prt_lastupdwhen | Date |
| | prt_temp | Description |
| | prt_vilkey | Description |
| | prt_storlen | Description |
| | prt_smptype | Description |
| | prt_key | Description |
| | prt_lastupdby | Description |
| | prt_sitkey | Description |
| Class NameClass Name | Class Type | Business Layer |
| bProtocolList | Property Name | |
| | prt_key | Description |
| | prt_temp | Description |
| | vil_type | Description |
| | prt_name | Description |
| | bxt_type | Description |
| | in_proname | Description |
| Class NameClass Name | Class Type | Business Layer |
| bProtocolManual | Property Name | |
| | smp_date2 | DOB |
| | smp_text3 | Description |
| | prt_message | Description |
| | smp_date1 | DOB |
| | smp_date3 | DOB |
| | smp_date4 | DOB |
| | smp_date5 | DOB |
| | smp_date6 | DOB |
| | smp_date7 | DOB |
| | smp_date8 | DOB |
| | smp_date9 | DOB |
| | smp_date10 | DOB |
| | smp_time1 | Description |
| | smp_time2 | Description |
| | smp_time3 | Description |
| | smp_time4 | Description |
| | smp_time5 | Description |
| | smp_time6 | Description |
| | smp_time7 | Description |
| | smp_time8 | Description |
| | smp_time9 | Description |
| | smp_time10 | Description |
| | smp_text1 | Description |
| | smp_text2 | Description |
| | prt_name | Description |
| | vil_type | Description |
| | bxt_type | Description |
| | trl_name | Description |
| | prt_frekey | Description |
| | prt_smptype | Description |
| | prt_smpfate | Description |
| | prt_stortype | Description |
| | prt_storlen | Description |
| | prt_temp | Description |
| | smp_key | Description |
| | smp_text4 | Description |
| | smp_text5 | Description |
| | smp_text6 | Description |
| | smp_text7 | Description |
| | smp_text8 | Description |
| | smp_text9 | Description |
| | smp_text10 | Description |
| | smp_numerical1 | Description |
| | smp_numerical2 | Description |
| | smp_numerical3 | Description |
| | smp_numerical4 | Description |
| | smp_numerical5 | Description |
| | smp_numerical6 | Description |
| | smp_numerical7 | Description |
| | smp_numerical8 | Description |
| | smp_numerical9 | Description |
| | smp_numerical10 | Description |
| | smp_id | Description |
| | smp_cstid | Description |
| | prt_key | Description |
| | smp_prtkey | Description |
| | smp_name | Description |
| Class NameClass Name | Class Type | Business Layer |
| bRole | Property Name | |
| | rol_active | Code |
| | rol_lastupdby | Description |
| | rol_lastupdaction | Description |
| | rol_key | Primary Key |
| | rol_name | Description |
| | rol_lastupdwhen | Description |
| Class NameClass Name | Class Type | Business Layer |
| bSeller | Property Name | |
| | ent_sel_dispute_val | Description |
| | ent_reg_name | Description |
| | trn_goodsdesc | Description |
| | trn_status | Description |
| | ent_key | Description |
| | trn_tran_date | Description |
| | trn_selref | Description |
| | trn_seltotal | Description |
| | ent_sel_debt | Description |
| | trn_buy_reg_name | Description |
| Class NameClass Name | Class Type | Business Layer |
| bvial | Property Name | |
| | smp_date2 | DOB |
| | smp_text3 | Description |
| | prt_message | Description |
| | smp_date1 | DOB |
| | smp_date3 | DOB |
| | smp_date4 | DOB |
| | smp_date5 | DOB |
| | smp_date6 | DOB |
| | smp_date7 | DOB |
| | smp_date8 | DOB |
| | smp_date9 | DOB |
| | smp_date10 | DOB |
| | smp_time1 | Description |
| | smp_time2 | Description |
| | smp_time3 | Description |
| | smp_time4 | Description |
| | smp_time5 | Description |
| | smp_time6 | Description |
| | smp_time7 | Description |
| | smp_time8 | Description |
| | smp_time9 | Description |
| | smp_time10 | Description |
| | smp_text1 | Description |
| | smp_text2 | Description |
| | prt_name | Description |
| | vil_type | Description |
| | bxt_type | Description |
| | trl_name | Description |
| | prt_frekey | Description |
| | prt_smptype | Description |
| | prt_smpfate | Description |
| | prt_stortype | Description |
| | prt_storlen | Description |
| | prt_temp | Description |
| | smp_key | Description |
| | smp_text4 | Description |
| | smp_text5 | Description |
| | smp_text6 | Description |
| | smp_text7 | Description |
| | smp_text8 | Description |
| | smp_text9 | Description |
| | smp_text10 | Description |
| | smp_numerical1 | Description |
| | smp_numerical2 | Description |
| | smp_numerical3 | Description |
| | smp_numerical4 | Description |
| | smp_numerical5 | Description |
| | smp_numerical6 | Description |
| | smp_numerical7 | Description |
| | smp_numerical8 | Description |
| | smp_numerical9 | Description |
| | smp_numerical10 | Description |
| | smp_id | Description |
| | smp_cstid | Description |
| | prt_key | Description |
| | smp_prtkey | Description |
| | smp_name | Description |
| | smp_lastupdwhen | Description |
| | bop_x | Description |
| | bop_y | Description |
| | box_key | Description |
| | smp_lastupdby | Description |
| | smp_lastupdaction | Description |
| Class NameClass Name | Class Type | Business Layer |
| bVialList | Property Name | |
| | prt_key | Description |
| | smp_key | Description |
| | smp_cstid | Description |
| | smp_id | Description |
| | smp_name | Description |
| | smp_desc | Description |
| | smp_loc | Description |
| | smp_freezer | Description |
| | trl_name | Description |
| | in_smpid | Description |
| | in_SmpcstId | Description |
| | in_boxid | Description |
| | in_Protocol | Description |
| Class NameClass Name | Class Type | Business Layer |
| bVialType | Property Name | |
| | ent_reg_name | Description |
| | in_vialtype | Description |
| | vil_entkey | Description |
| | vil_height | Description |
| | vil_key | Primary Key |
| | vil_lastupdaction | Description |
| | vil_lastupdby | Description |
| | vil_lastupdwhen | Date |
| | vil_material | Description |
| | vil_name | Description |
| | vil_outdia | Description |
| | vil_type | Description |
| | vil_volume | Description |
| Class NameClass Name | Class Type | User Layer |
| uBox | Property Name | |
| | box_active | Description |
| | smp_id | Description |
| | box_entkey | Description |
| | box_trlkey | Description |
| | box_name | Description |
| | box_id | Description |
| | box_cstid | Description |
| | box_height | Description |
| | box_width | Description |
| | box_depth | Description |
| | box_comments | Description |
| | smp_name | Description |
| | bxt_name | Description |
| | box_prtkey | Description |
| | box_prot | Description |
| | box_key | Description |
| | bxt_xstart | Description |
| | bxt_xlength | Description |
| | box_frekey | Description |
| | box_rcpkey | Description |
| | box_rckpos | Description |
| | box_shlpos | Description |
| | box_frepos | Description |
| | bop_x | Description |
| | bop_y | Description |
| | VialKey | Description |
| | smp_key | Description |
| | smp_cstid | Description |
| | bxt_type | Description |
| | bxt_ystart | Description |
| | bxt_ylength | Description |
| Class NameClass Name | Class Type | User Layer |
| uBoxList | Property Name | |
| | in_id | Description |
| | in_protocol | Description |
| | BoxCustid | Description |
| | Box_Protocol | Description |
| | Box_lastupdby | Description |
| | Box_lastupdaction | Description |
| | Box_key | Description |
| | in_cstid | Description |
| | Box_id | Description |
| | BoxName | Description |
| | box_location | Description |
| | Box_lastupdwhen | Description |
| Class NameClass Name | Class Type | User Layer |
| uBoxType | Property Name | |
| | Active | Description |
| | BxtName | Description |
| | Depth | Description |
| | Lastupdaction | Description |
| | Lastupdwhen | Date |
| | Width | Description |
| | Xstart | Description |
| | Ystart | Description |
| | BxtKey | Description |
| | Comments | Description |
| | Height | Description |
| | Lastupdby | Description |
| | Type | Description |
| | Xlength | Description |
| | Ylength | Description |
| Class NameClass Name | Class Type | User Layer |
| uBoxTypeList | Property Name | |
| | Lastupdwhen | Date |
| | Type | Description |
| | Width | Description |
| | xLength | Description |
| | Xstart | Description |
| | Lastupdby | Description |
| | Active | Description |
| | Ystart | Description |
| | BxtName | Description |
| | Height | Description |
| | in_Type | Description |
| | Comments | Description |
| | Lastupdaction | Description |
| | Depth | Description |
| | BoxTypeKey | Description |
| | YLength | Description |
| Class NameClass Name | Class Type | User Layer |
| uCapacityDetail | Property Name | |
| | bxt_freezer | Description |
| | col_NoofBoxes | Integer |
| | col_% full | Integer |
| | col_shelf | Description |
| | col_totalnoofboxes | Integer |
| | col_key | Integer |
| Class NameClass Name | Class Type | User Layer |
| uCapacitySearch | Property Name | |
| | bxt_site_name | Description |
| | col_% full | Integer |
| | col_freezer | Description |
| | col_site_name | Description |
| | col_customer | Description |
| | col_key | Integer |
| Class NameClass Name | Class Type | User Layer |
| uControl | Property Name | |
| | prt_key | Description |
| | ct2_visible | Description |
| | ct2_lastupdby | Description |
| | KeyRead | Description |
| | Text | Description |
| | ProtocolNames | Description |
| | Mandatory | Description |
| | Top | Description |
| | Height | Description |
| | TabIndex | Description |
| | ControlName | Description |
| | Keyct2read | Description |
| | Datatype | Description |
| | TabOrder | Description |
| | Left | Description |
| | Width | Description |
| | ct2_lastupdwhen | Date |
| Class NameClass Name | Class Type | User Layer |
| uDatatype | Property Name | |
| | dat_key | Description |
| | dat_lastupdwhen | Date |
| | dat_name | Description |
| | dat_lastupdby | Description |
| Class NameClass Name | Class Type | User Layer |
| uDataTypeList | Property Name | |
| | KeyType | Description |
| | scName | Description |
| | NameGrid | Description |
| Class NameClass Name | Class Type | User Layer |
| uEntity | Property Name | |
| | sckey | Integer |
| | ent_rg_psnkey | Description |
| | ACN | Description |
| | Deflockey | Description |
| | WebSite | Description |
| | Adminlockey | Description |
| | ABN | Description |
| | TradeName | Description |
| | ID | Description |
| | RegName | Description |
| | ent_hl_psnName | Description |
| | Since | Date |
| | DefaultLocation | Description |
| | wdg_HL_PsnKey | Description |
| | wdg_AdminKey | Description |
| | AdminLocation | Description |
| | ent_hl_psnkey | Description |
| | ent_rg_psnName | Description |
| | wdg_RG_PsnKey | Description |
| | wdg_DefdelKey | Description |
| | Lastupdby | Description |
| | Lastupdwhen | Date |
| | Lastupdaction | Description |
| | Active | Description |
| Class NameClass Name | Class Type | User Layer |
| uEntityList | Property Name | |
| | scID | Description |
| | vlAddress | Description |
| | vlRegName | Description |
| | scName | Description |
| | vlKey | Description |
| | vlID | Description |
| Class NameClass Name | Class Type | User Layer |
| ufreezer | Property Name | |
| | EdtShlXStart | Description |
| | EdtComment | Description |
| | EdtShlYStart | Description |
| | EdtPolFreq | Description |
| | EdtRckXStart | Description |
| | EdtRckYStart | Description |
| | EdtFreezerkey | Integer |
| | edtFreXStart | Description |
| | FreType | Integer |
| | EdtLastUpDate | Date |
| | EdtKeyBack | Integer |
| | FreBarcode | Bar Code |
| | EdtMaxTemp | Description |
| | EdtOwnedBy | Bar Code |
| | FreName | Description |
| | EdtMinTemp | Description |
| | edtFreXLen | Integer |
| | FreSite | Description |
| | edtFreYStart | Description |
| | EdtFreYLen | Integer |
| | EdtNoShelves | Integer |
| | EdtShlXLen | Integer |
| | EdtShlYLen | Integer |
| | EdtRckXLen | Integer |
| | FreNoLoc | Integer |
| | EdtRckYLen | Integer |
| Class NameClass Name | Class Type | User Layer |
| ufreList | Property Name | |
| | FreKey | Description |
| | scFreID | Description |
| | scFreName | Description |
| | FreBarCodeGrid | Description |
| | FreNameGrid | Description |
| | FreNoShelvesGrid | Description |
| Class NameClass Name | Class Type | User Layer |
| UGenericScreens | Property Name | |
| | tst_CountryCode | Code |
| | tst_StateCode | Code |
| Class NameClass Name | Class Type | User Layer |
| uLocation | Property Name | |
| | EAN | Description |
| | Type | Description |
| | ShortName | Description |
| | Address2 | Description |
| | City | Description |
| | Postcode | Description |
| | Phone | Description |
| | Fax | Description |
| | LocKey | Description |
| | LocEntKey | Description |
| | EntRegName | Description |
| | Status | Description |
| | LocName | Description |
| | Address1 | Description |
| | Address3 | Description |
| | State | Description |
| | Country | Description |
| | LocNotes | Description |
| | LastUpdBy | Description |
| | LastUpdWhen | Date |
| | LastUpdAction | Description |
| | Address4 | Description |
| Class NameClass Name | Class Type | User Layer |
| uLocationList | Property Name | |
| | scEntKey | Description |
| | scType | Description |
| | scShortName | Description |
| | locEntKey | Description |
| | locEAN | Description |
| | locType | Description |
| | locShortName | Description |
| | locPhone | Description |
| | locFax | Description |
| | scName | Description |
| | locKey | Description |
| | locEntRegName | Description |
| | locStatus | Description |
| | locName | Description |
| | locAddress1 | Description |
| | locAddress2 | Description |
| | locAddress3 | Description |
| | locAddress4 | Description |
| Class NameClass Name | Class Type | User Layer |
| uPerson | Property Name | |
| | InitialCallKey | Description |
| | PersonType | Description |
| | PsnKey | Description |
| | PersonTitle | Description |
| | GivenName | Description |
| | PreferredName | Description |
| | MothersName | Description |
| | WorkFax | Description |
| | HomePhone | Description |
| | HomeEmail | Description |
| | Active | Description |
| | FamilyName | Description |
| | NameSuffix | Description |
| | DOB | DOB |
| | WorkPhone | Description |
| | WorkEmail | Description |
| | HomeFax | Description |
| | FormedName | Description |
| | RoleKey | Description |
| | RoleName | Description |
| | UserName | Description |
| | Password | Description |
| | LastUpdBy | Description |
| | LastUpdWhen | Date |
| | LastUpdAction | Description |
| | Description | Description |
| | Notes | Description |
| | RoleEntity | Description |
| | PerKey | Description |
| | Status | Description |
| | zTab4EntKey | Description |
| | zTab4RoleKey | Description |
| | PreKey | Description |
| Class NameClass Name | Class Type | User Layer |
| uPersonList | Property Name | |
| | scFamilyName | Description |
| | scDOB | DOB |
| | vlStatus | Description |
| | vlWorkPhone | Description |
| | vlFormedName | Description |
| | vlWorkEmail | Description |
| | scGivenName | Description |
| | vlWorkFax | Description |
| | vlPsnKey | Primary Key |
| | vlDOB | Date |
| Class NameClass Name | Class Type | User Layer |
| uProtocol | Property Name | |
| | BoxType | Description |
| | SampleFate | Description |
| | TrialName | Description |
| | Message | Description |
| | Location | Description |
| | Name | Description |
| | prt_lastupdby | Description |
| | prt_trlkey | Description |
| | prt_sitkey | Description |
| | VialType | Description |
| | prt_temp | Description |
| | StorageLen | Description |
| | SampleType | Description |
| | Time | Date |
| | prt_key | ItemNo |
| | prt_lastupdwhen | Date |
| Class NameClass Name | Class Type | User Layer |
| uProtocolList | Property Name | |
| | scName | Description |
| | vlType | Description |
| | vlStorageTemp | Description |
| | vlName | Description |
| | vlBoxType | Description |
| | vlKey | Description |
| Class NameClass Name | Class Type | User Layer |
| uRole | Property Name | |
| | rol_active | Code |
| | rol_lastupdby | Description |
| | rol_lastupdaction | Description |
| | rol_key | Primary Key |
| | rol_name | Description |
| | rol_lastupdwhen | Description |
| Class NameClass Name | Class Type | User Layer |
| uRoleList | Property Name | |
| | scEntityName | Description |
| | scPersonName | Description |
| Class NameClass Name | Class Type | User Layer |
| uVial | Property Name | |
| | Protocol Name | Description |
| | Barcode | Description |
| | KeyRead | Description |
| | BoxType | Description |
| | Samplefate | Description |
| | TrialName | Description |
| | Message | Description |
| | Location | Description |
| | Date2 | Date |
| | Date4 | Date |
| | Date6 | Date |
| | Date8 | Date |
| | Date10 | Date |
| | Time2 | Description |
| | Time4 | Description |
| | Time6 | Description |
| | Time8 | Description |
| | Time10 | Description |
| | Text2 | Description |
| | Text4 | Description |
| | Time5 | Description |
| | Text7 | Description |
| | Text9 | Description |
| | Numerical1 | Integer |
| | CustID | Description |
| | Lastupdby | Description |
| | Lastupdaction | Description |
| | PosX | Description |
| | PosY | Description |
| | BoxKey | Description |
| | VialType | Description |
| | StorageTemp | Description |
| | StorageLen | Description |
| | SampleType | Description |
| | Time | Description |
| | Date1 | Date |
| | Date3 | Date |
| | Date5 | Date |
| | Date7 | Date |
| | Date9 | Date |
| | Time1 | Description |
| | Time3 | Description |
| | Time7 | Description |
| | Time9 | Description |
| | Text1 | Description |
| | Text3 | Description |
| | Text5 | Description |
| | Text6 | Description |
| | Text8 | Description |
| | Text10 | Description |
| | Numerical2 | Integer |
| | Numerical3 | Integer |
| | Numerical4 | Integer |
| | Numerical5 | Integer |
| | Numerical6 | Integer |
| | Numerical7 | Integer |
| | Numerical8 | Integer |
| | Numerical9 | Integer |
| | Numerical10 | Integer |
| | Lastupdwhen | Description |
| | Samplename | Description |
| | KeyPro | Description |
| Class NameClass Name | Class Type | User Layer |
| uVialList | Property Name | |
| | Prt_Key | Description |
| | scProtcol | Description |
| | BoxKey | Description |
| | scClientlD | Description |
| | scVialbarcode | Description |
| | scSmpName | Description |
| | sctrlName | Description |
| | Barcode | Description |
| | ClientCode | Description |
| | VialFreezer | Description |
| | VialDesc | Description |
| | TrialName | Description |
| | BoxId | Description |
| | VialKey | Description |
| | VialLoc | Description |
| Class NameClass Name | Class Type | User Layer |
| uVialType | Property Name | |
| | EntName | Description |
| | VilKey | Primary Key |
| | Lastupdby | Description |
| | Material | Description |
| | OutDiameter | Description |
| | Type | Description |
| | EntKey | Description |
| | Height | Description |
| | Lastupdaction | Description |
| | Lastupdwhen | Description |
| | Name | Description |
| | Volume | Description |
| Class NameClass Name | Class Type | User Layer |
| uVialTypeList | Property Name | |
| | in_VialType | Description |
| | Lastupdaction | Description |
| | Lastupdby | Description |
| | Lastupdwhen | Date |
| | Name | Description |
| | OutDiameter | Description |
| | Volume | Description |
| | VialType | Description |
| | Height | Description |
| | Key | Primary Key |

The present invention has been hereinbefore described with reference to a specific embodiment. It will be appreciated by persons skilled in the art that numerous variations and modifications to the specific embodiment may be made. All such variations and modifications should be considered to fall within the scope of the invention as broadly hereinbefore described and as hereinafter claimed.

The claims:

1. A system for the management of stored biological specimens, including:
a repository of biological specimens, each specimen having sample data pertaining thereto;
a processor, accessed by one or more user from a remote location via a communications carrier, such as via the internet including:
a database containing profile data correlating to said sample data and user determined data;
identification means to determine the identity of each of said one or more users, wherein said identification means includes the supply of a user name and password, the use of biometric identification means, or other like identification means;
authentication means to authenticate the authority of said one or more users, is wherein each said one or more users may have differing authority levels;
searching means for said one or more user to search said database; and
control means, for said one or more user to remotely control the management of said specimens, by inputting and/or manipulating said user defined data, including the retrieval, delivery and disposal of each sample, and, the environmental conditions in which each sample is stored.

2. A system as claimed in of claim 1, wherein said specimens are biological samples, plant extracts, insects, or other like specimens.

3. A system as claimed in claim 1 or 2, wherein said stored biological specimens are stored under ambient, refrigerated, frozen, ultracold, cryogenic, or other environmental conditions.

4. A system as claimed in any one of claims 1 to 3, wherein said environmental conditions includes temperature, humidity, etc., of one or more freezer unit.

5. A system as claimed in any one of claims 1 to 4, wherein said environmental conditions may be set or adjusted.

6. A system as claimed in any one of claims 1 to 5, wherein said system includes logging means, to record ongoing data pertaining to each sample/specimen or groups of samples/specimens.

7. A system as claimed in claim 6, wherein historical data pertaining to said sample/specimen or groups of samples/specimens is retrievable from said logging means.

8. A system as claimed in any one of claims 1 to 7, wherein said system further includes analysing means to analyse data pertaining to a sample/specimen or groups of samples/specimens, produce reports thereabouts, etc.

9. A system as claimed in any one of claims 1 to 8, wherein said system uses a graphical interface.

10. A system as claimed in any one of claims 1 to 9 wherein said system includes replication and queuing means.

11. A system as claimed in any one of claims 1 to 10, wherein said system is used for the management of biological samples or other specimens by academic and/or research institutions, pathology practices, clinical trial purposes, agricultural purposes, etc.

12 A method for managing the storage of biological specimens, including the steps of:
providing a repository of biological specimens, each specimen having been sampled to obtain sample data pertaining thereto;
entering profile data, correlating to said sample data of said biological specimens into a database;
managing the identification retrieval, delivery and disposal of each sample, and, the environmental conditions in which each sample is stored via a control means by one or ore user located at a remote location, such as via the internet, said managing step including:
identifying each of said one or more users by the supply of a user name and password, the user of biometric identification means or other like identification means;
authenticating the authority of said one or more user, wherein each of said one or more user may have a differing authority level; and,
searching, and inputting and/or manipulating user defined data into said database to thereby remotely control the management of said specimens.

13. A method as claimed in claim 12, wherein said specimens are biological samples, plant extracts, insects, or other like specimens.

14. A method as claimed in claim 12 or 13, wherein said stored biological specimens are stored under ambient, refrigerated, frozen, ultracold, cryogenic, or other environmental conditions.

15 A method as claimed in any one of claims 12 to 14, wherein, in said managing step, the temperature, humidity, etc., of said environmental conditions are set, adjusted or otherwise controlled.

16. A method as claimed in any one of claims 12 to 15, further including the step of:
recording, in a logging means, data pertaining to each specimen.

17. A method as claimed in claim 16, further including the step of:
analysing data pertaining to each specimen, to produce reports thereabouts, etc.

18. A method as claimed in any one of claims 12 to 17, wherein said method is used for the management of biological samples or other specimens by academic and/or research institutions, pathology practices, clinical trial purposes, agricultural purposes, etc.
